(19) United States
(12) Patent Application Publication
(10) Pub. No.: US 2023/0176904 A1
(43) Pub. Date: Jun. 8, 2023

(54) CONTROL DEVICE, CONTROL METHOD AND CONTROL PROGRAM

(71) Applicant: Nippon Telegraph and Telephone Corporation, Tokyo (JP)

(72) Inventors: Yuichi SUTO, Musashino-shi, Tokyo (JP); Aiko OI, Musashino-shi, Tokyo (JP); Ryosuke SATO, Musashino-shi, Tokyo (JP); Kosuke SAKATA, Musashino-shi, Tokyo (JP); Motomu NAKAJIMA, Musashino-shi, Tokyo (JP); Yoshikazu HAGIWARA, Musashino-shi, Tokyo (JP); Tsuyoshi FURUKAWA, Musashino-shi, Tokyo (JP)

(21) Appl. No.: 17/924,492

(22) PCT Filed: May 11, 2020
(86) PCT No.: PCT/JP2020/018821

§ 371 Date: Nov. 10, 2022

(51) Int. Cl. G06F 9/48; G06F 11/07

(52) U.S. Cl. CPC G06F 9/4881; G06F 11/0757

(57) ABSTRACT

A control device includes: an identification unit identifying a workflow waiting to execute an aggregation object process in aggregation rule data, an aggregation unit associating an identifier of the identified workflow with an aggregation identifier associated with a process that the identified workflow is waiting to execute and an aggregation condition identified from an attribute of the identified workflow in the aggregated data; and an execution unit outputting an instruction to aggregate and execute a process that the workflow associated with the aggregation identifier in the aggregated data is waiting to execute.

### TECHNICAL FIELD

The present invention relates to a control device, a control method, and a control program.

### BACKGROUND ART

In dealing with failure of a network device, there has been an attempt in which a computer such as a workflow engine (WFE) deals with failure according to predetermined processes using an alarm issued by a network device or a monitoring device that monitors the network device as a trigger.

For example, there has been a system in which a Web front-end can be used to perform operations such as suspending/stopping the workflow during execution based on the workflow definition before execution and resuming the operation by receiving input of information (see Non-Patent Literature 1).

### CITATION LIST

### Non-Patent Literature

Non-Patent Literature 1: Stack Storm, “StackStorm Overview”, [online], [searched on Apr. 20, 2020], Internet <URL: https://docs.stackstorm.com/overview.html>

### SUMMARY OF THE INVENTION

### Technical Problem

The method described in Non-Patent Literature 1 is for operating a workflow based on the workflow definition before execution, and is merely for controlling the progression of the processes in the workflow before execution. Therefore, the method described in Non-Patent Literature 1 cannot flexibly aggregate processes by comparing workflows during execution.

The present invention has been made in view of the above circumstances, and an object of the present invention is to provide a technique capable of flexibly aggregating processes in workflows during execution.

### Means for Solving the Problem

A control device according to an aspect of the present invention includes: a storage device that stores aggregation rule data that associates an aggregation object process of processes in a workflow in which a computer deals with failure of a device with an aggregation condition identified from an attribute of the workflow, and aggregated data that associates an identifier of an aggregation object workflow with an aggregation identifier and also associates an aggregation object process and an aggregation condition identified from an attribute of the aggregation object workflow with the aggregation identifier; an identification unit that identifies a workflow waiting to execute an aggregation object process in the aggregation rule data; an aggregation unit that associates an identifier of an identified workflow with an aggregation identifier associated with a process that the identified workflow is waiting to execute and an aggregation condition identified from an attribute of the identified workflow in the aggregated data; and an execution unit that outputs an instruction to aggregate and execute a process that the workflow associated with the aggregation identifier in the aggregated data is waiting to execute.

A control method according to an aspect of the present invention includes: a step of storing in a storage device, by a computer, aggregation rule data that associates an aggregation object process of processes in a workflow for dealing with failure of a device with an aggregation condition identified from an attribute of the workflow, and aggregated data that associates an identifier of an aggregation object workflow with an aggregation identifier and also associates an aggregation object process and an aggregation condition identified from an attribute of the aggregation object workflow with the aggregation identifier; a step of identifying, by the computer, a workflow waiting to execute an aggregation object process in the aggregation rule data; a step of associating, by the computer, an identifier of an identified workflow with an aggregation identifier associated with a process that the identified workflow is waiting to execute and an aggregation condition identified from an attribute of the identified workflow in the aggregated data; and a step of outputting, by the computer, an instruction to aggregate and execute a process that the workflow associated with the aggregation identifier in the aggregated data is waiting to execute.

An aspect of the present invention is a control program for causing a computer to function as the control device described above.

### Effects of the Invention

According to the present invention, it is possible to provide a technique capable of flexibly aggregating processes in workflows during execution.

### BRIEF DESCRIPTION OF DRAWINGS

FIG. 1 is a diagram illustrating functional blocks of a control device according to an embodiment of the present invention.

FIG. 2 is a diagram illustrating an example of a data structure of workflow data.

FIG. 3 is a diagram illustrating an example of a data structure of aggregation rule data.

FIG. 4 is a diagram illustrating an example of a data structure of aggregated data.

FIG. 5 is a flowchart illustrating identification processing performed by an identification unit.

FIG. 6 is a flowchart illustrating aggregation processing performed by an aggregation unit.

FIG. 7 is a flowchart illustrating execution processing (tail aggregation) performed by an execution unit.

FIG. 8 is a flowchart illustrating execution processing (head aggregation) performed by the execution unit.

FIG. 9 is a sequence diagram illustrating processing in which tail aggregation is performed (part 1).

FIG. 10 is a sequence diagram illustrating processing in which tail aggregation is performed (part 2).

FIG. 11 is a sequence diagram illustrating processing in which head aggregation is performed (part 1).

FIG. 12 is a sequence diagram illustrating processing in which head aggregation is performed (part 2).

FIG. 13 is a diagram illustrating a hardware configuration of a computer used for the control device.

### DESCRIPTION OF EMBODIMENTS

Hereinafter, an embodiment of the present invention will be described with reference to the drawings. In the description of the drawings, the same parts are given the same reference numeral and the description thereof will be omitted.

### Control Device

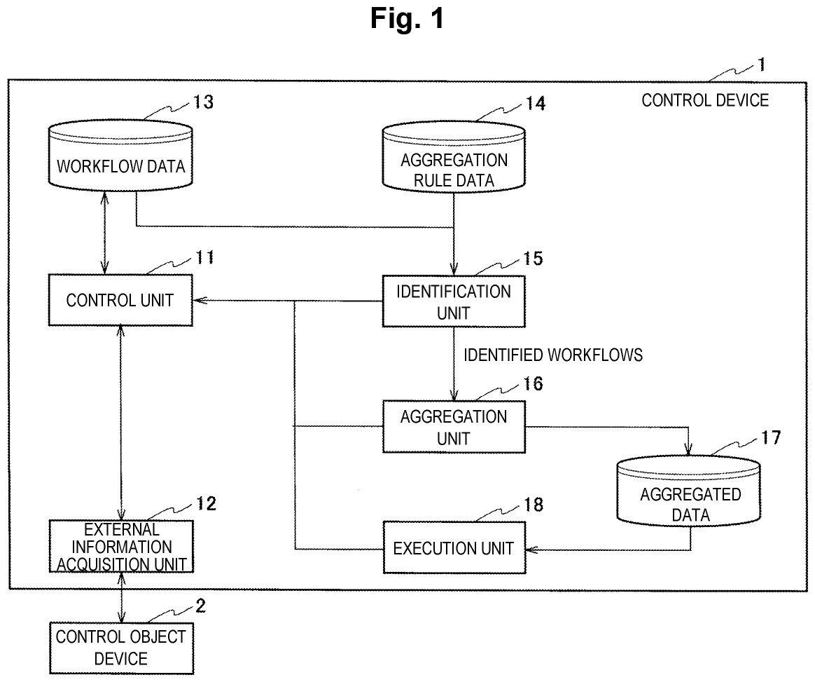

A control device 1 according to an embodiment of the present invention will be described with reference to FIG. 1. The control device 1 is a computer that deals with failure in a control object device 2 according to a workflow composed of a plurality of processes. A workflow includes processes such as checking whether the failure is due to past work, referring to information of the operation supporting system for the device, arranging to transport a spare machine, and acquiring recovery information after restarting the device as failure responses. In a workflow, the content of the next process is determined based on the result of the previous process.

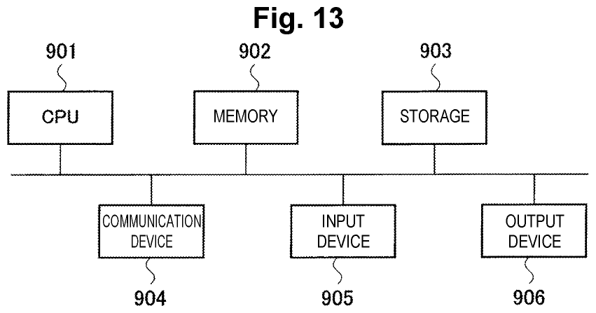

The control device 1 includes a control unit 11, an external information acquisition unit 12, workflow data 13, aggregation rule data 14, an identification unit 15, an aggregation unit 16, aggregated data 17, and an execution unit 18. The workflow data 13, the aggregation rule data 14, and the aggregated data 17 are data stored in a storage device (a memory 902 or a storage 903 in FIG. 13). The control unit 11, the external information acquisition unit 12, the identification unit 15, the aggregation unit 16, and the execution unit 18 are functions that are implemented on a computer by causing a processing device (a CPU 901 in FIG. 13) to execute a control program.

The control unit 11, the external information acquisition unit 12, and the workflow data 13 deal with failure in the control object device 2 according to a workflow. A workflow is predefined in data (not shown) that can be referred to by the control unit 11 and the like. Although only one control object device 2 is shown in FIG. 1, the control device 1 may control a plurality of control object devices.

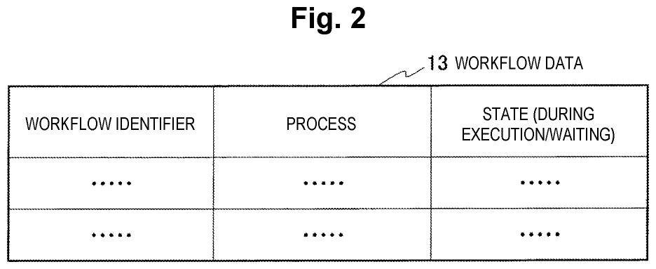

The workflow data 13 records the progress of a workflow currently being executed by the control unit 11. As shown in FIG. 2, the workflow data 13 holds an identifier of a workflow currently being executed, the process being executed, the progress of the workflow, and the like in association with each other. The workflow data 13 may further associate the execution result of the process by the control unit 11 with the identifier of the workflow currently being executed.

The control unit 11 controls execution of a workflow. The control unit 11 executes failure response according to a predefined workflow using an alarm generated in the control object device 2 as a trigger. The control unit 11 acquires information of the control object device 2 or inputs an instruction to the control object device 2 via the external information acquisition unit 12. The control unit 11 may be provided for each workflow being executed. The control unit 11 executes a process according to a workflow and executes the next process according to the execution result of the process. The control unit 11 stores the execution result of each workflow in the workflow data 13.

In the embodiment of the present invention, when having completed one process, the control unit 11 waits to execute the next process. The control unit 11 executes the next process or cancels execution of the next process according to an instruction from the identification unit 15, the aggregation unit 16, or the execution unit 18.

The external information acquisition unit 12 is an interface via which the control device 1 connects to the control object device 2. The external information acquisition unit 12 acquires information of the control object device 2 or inputs an instruction to the control object device 2 according to an instruction from the control unit 11.

The aggregation rule data 14, the identification unit 15, the aggregation unit 16, the aggregated data 17, and the execution unit 18 identify workflows that are waiting to execute aggregatable processes among workflow data currently being executed, and aggregate and execute the aggregatable processes in the workflows.

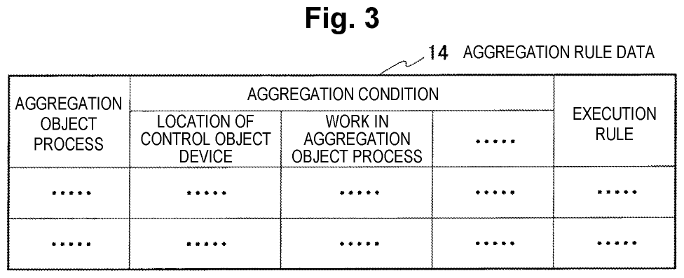

The aggregation rule data 14 defines rules for identifying aggregation objects. As shown in FIG. 3, the aggregation rule data 14 associates an aggregation object process of processes in a workflow in which a computer (control unit 11) deals with failure of the control object device 2 with an aggregation condition identified from attributes of the workflow. The aggregation object process is one of the processes defined by the workflow.

The aggregation condition is, for example, the location and type of the control object device for which the workflow being executed deals with the failure and specific work to be performed in the process. The aggregation condition may be set in any way as long as aggregation object workflows can be identified. When a specific building name such as “‘A’ building” is set, aggregation object processes ‘related to the ‘A building are aggregated. When an abstract location such as “the same building” is set, aggregation object processes are aggregated that are related to a specific building (such as the ‘A building) where the control object device 2 for which the workflow first associated with this aggregation rule deals with the failure is located. Conditions having effects such as being capable of reducing costs by aggregation are set in the aggregation condition.

As shown in FIG. 3, the aggregation rule data 14 may be provided with a flag for distinguishing between tail aggregation and head aggregation as an execution rule. Each of tail aggregation and head aggregation is a method of executing aggregated processes in workflows and will be described later in detail.

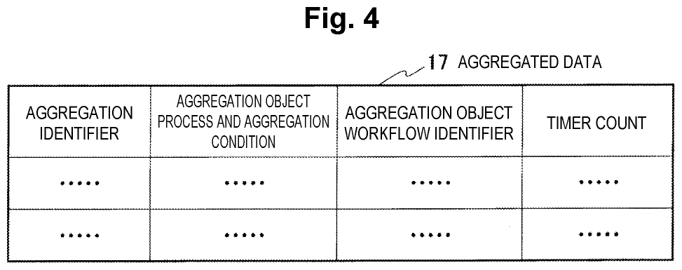

The aggregated data 17 identifies workflows that are aggregated workflows and are currently waiting to be executed. As shown in FIG. 4, the aggregated data 17 associates the identifier of an aggregation object workflow with an aggregation identifier and also associates the aggregation object process and the aggregation condition identified from the attributes of the aggregation object workflow with the aggregation identifier. Here, a specific condition identified from the aggregated workflow such as “‘A’ building” is set as the aggregation condition.

An aggregation object workflow identifier is the identifier of an aggregation object workflow associated with this aggregation identifier. When a new workflow has occurred that has the process and the aggregation condition identified from the attributes matched with those of the aggregation object workflow while this workflow is waiting to be executed, the identifier of the new workflow is added as an aggregation object workflow identifier.

A timer count is the count of a timer for collecting aggregation object workflows. The timer count may be of a count-up type or a count-down type. When the timer has expired, the waiting processes in the workflows associated as the aggregation object workflow identifiers are aggregated and executed.

When the timer count has expired and the aggregation object workflows associated with the aggregation identifier have been processed, the data associated with the aggregation identifier may be deleted from the aggregated data 17.

The identification unit 15 identifies workflows waiting to execute an aggregation object process in the aggregation rule data 14. The identification unit 15 identifies a workflow in which the next process is matched with an aggregation object process and an aggregation condition in the aggregation rule data 14 among the workflows waiting to execute the next process as a workflow waiting to execute the aggregation object process.

In the embodiment of the present invention, when having completed execution of one process, the control unit 11 that controls execution of the workflow waits before executing the next process. For a workflow waiting to execute the next process, the identification unit 15 acquires the next process that the workflow is waiting for and the attributes from the control unit 11. The identification unit 15 determines whether the acquired process and attributes are matched with an aggregation object process and an aggregation condition in the aggregation rule data 14, and identifies the matched workflow as a workflow waiting to execute the aggregation object process.

Several ways are conceivable for the identification unit 15 to acquire the next process that the workflow is waiting for and the attributes. For example, the identification unit 15 may make an inquiry to the control unit 11 and acquire the next process that the workflow is waiting for and the attributes as its response. Alternatively, for a workflow that has completed the previous process and has entered the state of waiting for the next process, the control unit 11 may voluntarily notify the identification unit 15 of the next process that the workflow is waiting for and the attributes. Further, the identification unit 15 may refer to the workflow data 13 to acquire the next process that the workflow is waiting for and the attributes.

The identification unit 15 notifies the aggregation unit 16 of the identifier of a workflow that is identified as a workflow waiting to execute an aggregation object process. Further, when the next process is not an aggregation object process for a workflow waiting to execute the next process, the identification unit 15 outputs an instruction to execute the next process. The control unit 11 continues to wait to execute the next process for a workflow that is an aggregation object, while the control unit 11 executes the next process for a workflow that is not an aggregation object when receiving the instruction from the identification unit 15.

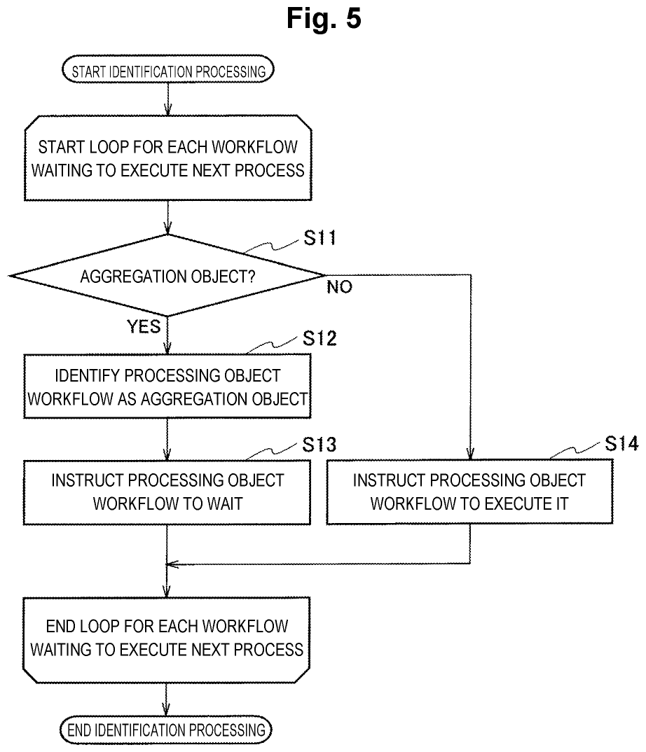

Identification processing performed by the identification unit 15 will be described with reference to FIG. 5.

The identification unit 15 performs the processing of steps S11 to S14 for each workflow waiting to execute the next process.

First, in step S11, the identification unit 15 determines whether a processing object workflow is an aggregation object. The identification unit 15 compares the processing object workflow with the aggregation rule data 14.

When it is determined to be an aggregation object, the identification unit 15 identifies the processing object workflow as an aggregation object workflow in step S12, and instructs the processing object workflow to further wait to execute the next process in step S13.

When it is determined not to be an aggregation object, the identification unit 15 instructs the processing object workflow to execute the next process in step S14.

When having completed the processing of steps S11 to S14 for each workflow waiting to execute the next process, the identification unit 15 ends the processing.

Note that the processing shown in FIG. 5 is an example and not limited to this.

The aggregation unit 16 aggregates the aggregation object workflows identified by the identification unit 15. When the attributes of an aggregation object workflow identified by the identification unit 15 have already been defined in the aggregated data 17, the aggregation unit 16 associates the identifier of the identified workflow with the aggregation identifier associated with the process that the identified workflow is waiting to execute and the aggregation condition identified from the attributes of the identified workflow in the aggregated data 17.

When the process and attributes of an aggregation object workflow identified by the identification unit 15 have not already been defined in the aggregated data 17, the aggregation unit 16 associates the identifier of the aggregation object workflow identified by the identification unit 15, the waiting process, and the aggregation condition identified from its attributes with a newly assigned aggregation identifier. Furthermore, the aggregation unit 16 associates a newly started timer count with the newly assigned identifier.

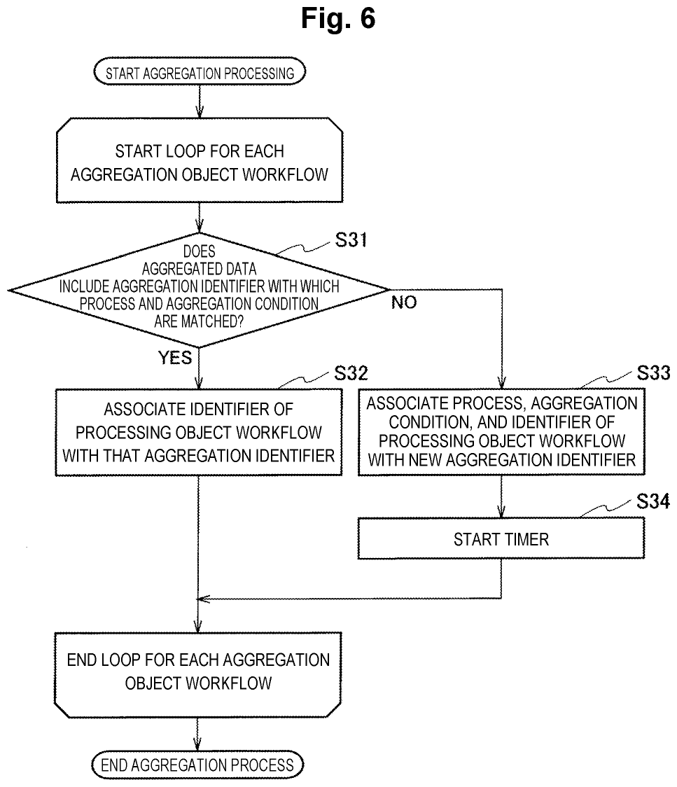

Aggregation processing performed by the aggregation unit 16 will be described with reference to FIG. 6.

The aggregation unit 16 performs the processing of steps S31 to S34 for each aggregation object workflow identified by the identification unit 15.

First, in step S31, the aggregation unit 16 determines whether an aggregation identifier is present for which the process and the attributes of the processing object workflow are matched with the aggregation object process and the aggregation condition in the aggregated data 17.

When the aggregated data 17 includes an aggregation identifier that is matched with the processing object process and the attributes, the aggregation unit 16 associates the identifier of the processing object workflow with the aggregation identifier with which the process and attributes of the processing object workflow are matched as the identifier of an aggregation object workflow in step S32.

When the aggregated data 17 does not include an aggregation identifier that is matched with the processing object process and the attributes, the aggregation unit 16 associates the process and the aggregation condition identified from the processing object workflow with a new aggregation identifier also associates the identifier of the processing object workflow thereto to update the aggregated data 17 in step S33. In step S34, the aggregation unit 16 starts a timer corresponding to the new aggregation identifier and associates its timer count with the new aggregation identifier to update the aggregated data 17.

When having completed the processing of steps S31 to S34 for each aggregation object workflow, the aggregation unit 16 ends the processing.

Note that the processing shown in FIG. 6 is an example and not limited to this.

The execution unit 18 outputs an instruction to aggregate and execute processes that the workflows associated with an aggregation identifier in the aggregated data 17 are waiting to execute. Here, “aggregate and execute” means to collectively execute the execution contents so that the aggregation object workflows can all execute the next waiting process. For example, when the aggregation object workflows give instructions to different devices, the execution unit 18 collectively gives instructions to the devices to be instructed on behalf of the workflows.

When it suffices to execute the next waiting process once, the execution unit 18 executes it only once. For example, even when each aggregation object workflow instructs one device to restart in the next waiting process, the execution unit 18 gives an instruction to restart to that one device once. When each aggregation object workflow acquires predetermined information from one device in the next waiting process, the execution unit 18 acquires the information from the device and provides the acquired information to each workflow.

The execution unit 18 itself may execute the process that each workflow is waiting to execute. Alternatively, the execution unit 18 may cause the control unit 11 to execute the workflow waiting to be executed. Specifically, for one of the workflows associated with an aggregation identifier in the aggregated data 17, the execution unit 18 inputs, to the control unit 11, an instruction to aggregate and execute the process that the workflow is waiting to execute. At this time, the execution unit 18 outputs, to the control unit 11, an instruction to cancel the execution for the workflows other than the workflow for which the instruction is input among the workflows associated with the aggregation identifier. The execution unit 18 selects a workflow to be given an execution instruction from the plurality of workflows associated with the aggregation identifier to be executed, and instructs the control unit 11 to execute the next process for the selected workflow. The execution unit 18 instructs the control unit 11 to cancel the execution of the next process for the other workflows that have not been selected.

The execution unit 18 outputs an instruction to aggregate and execute aggregation object workflows associated with an aggregation identifier by the time the timer held by the aggregated data 17 expires. Specifically, the execution unit 18 outputs an instruction to aggregate and execute the process that the workflows associated with the aggregation identifier in the aggregated data 17 by the time the timer for specifying the timing to execute the process expires are waiting to execute.

Although the embodiment of the present invention describes a case where the timer is started when a new aggregation identifier is assigned, there is no limitation to this. For example, it is also possible to periodically start a timer for each aggregation rule and aggregation condition and aggregate and process workflows that are aggregated by the time the timer expires. Further, although the embodiment of the present invention describes a case where a timer is provided for each aggregation identifier, a timer common to aggregation identifiers at intervals of one minute, ten seconds, etc. may be used.

As the timing when the aggregation object workflows execute the next waiting process, the embodiment of the present invention has tail aggregation and head aggregation.

Tail aggregation means to perform aggregation and execution after the timer has expired. Tail aggregation is suitable when the process waiting to be executed relates to an operation on another device. In tail aggregation, the execution unit 18 outputs an instruction to aggregate and execute an operation on another device executed by each workflow associated with the aggregation identifier after the timer has expired.

For example, when the next waiting process is “arranging to transport a spare machine”, the execution unit 18 outputs, to the control unit 11, an instruction to collectively execute the contents of arranging to transport a spare machine for each workflow associated with the aggregation identifier by the time the timer expires by tail aggregation. Since the contents of a plurality of arrangements to transport a spare machine can be executed collectively, costs can be reduced.

Further, when the next waiting process relates to “acquiring recovery information after restarting the device”, the execution unit 18 can collectively execute it by tail aggregation, so that costs can be reduced. Further, since the execution unit 18 can secure the time required for restarting the device and then acquire the recovery information, acquisition of the recovery information is not repeated while waiting for the restart, so that costs can be reduced. Note that after acquiring the recovery information, the execution unit 18 provides the recovery information to the control unit 11 for each workflow associated with the aggregation identifier by the time the timer expires. The control unit 11 executes the process after the next according to the provided recovery information.

In tail aggregation, when causing one of the workflows associated as aggregation objects to be executed, it is preferable to cause the workflow associated as an aggregation object immediately before the timer expires to be executed. Specifically, the execution unit 18 outputs, to the control unit 11, an instruction to wait to be executed for the workflow associated as an aggregation object first. After that, when a workflow newly associated as an aggregation object has occurred, the execution unit 18 instructs the control unit 11 to cancel the execution for the waiting workflow associated as an aggregation object first. This processing is repeated, and after the timer has expired, an instruction to aggregate and execute the next process is input to the control unit 11 for the workflow associated as an aggregation object last. In this way, in tail aggregation, it is possible to reduce the time for the control unit 11 to wait for an execution instruction from the execution unit 18 for each workflow.

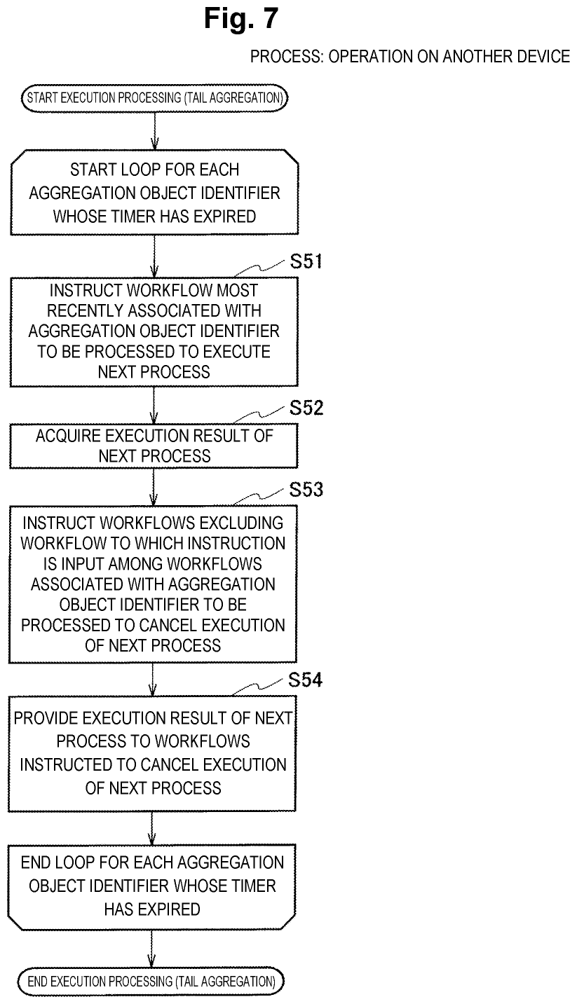

Execution processing performed by the execution unit 18 will be described with reference to FIG. 7. Here, a case will be described where the next waiting process is an operation on another device and the execution unit 18 outputs an execution instruction to the most recently associated workflow by tail aggregation.

The execution unit 18 performs the processing of step S51 and step S52 for each aggregation object identifier whose timer has expired and for which tail execution is performed.

In step S51, the execution unit 18 instructs the control unit 11 to execute the next process for the workflow most recently associated with the aggregation object identifier to be processed. In step S52, the execution unit 18 acquires the execution result from the workflow instructed to execute the next process.

In step S53, the execution unit 18 instructs the control unit 11 to cancel the execution of the next process for the workflows excluding the workflow instructed to execute the next process in step S51 among the workflows associated with the aggregation object identifier to be processed. In step S54, the execution unit 18 provides the execution result of the next process acquired in step S52 to each workflow instructed to cancel the execution of the next process in step S53.

When having completed the processing of steps S51 to S54 for each aggregation object identifier whose timer has expired, the aggregation unit 16 ends the processing.

Note that the processing shown in FIG. 7 is an example and not limited to this. In the example shown in FIG. 7, the execution unit 18 gives an instruction to cancel the execution of the next process when the timer has expired, but each time a new aggregation object workflow occurs, the previous aggregation object workflow may be instructed to cancel the execution of the next process. Further, in the example shown in FIG. 7, it is sufficient for the execution unit 18 to acquire the execution result of the next process and then provide the execution result to each workflow, and there is no limitation to the processing order shown in FIG. 7.

Head aggregation means that it is executed when the timer is started and each aggregation object workflow will executes the next waiting process by the time the timer expires. Head aggregation is suitable when the process waiting to be executed relates to referring to information. In head aggregation, after the timer is started, the execution unit 18 outputs an instruction to acquire information and outputs, to the control unit 11, an instruction to provide the information to each workflow associated with the aggregation identifier.

In head aggregation, when causing one of the workflows associated as aggregation objects to be executed, it is preferable to cause the workflow associated as an aggregation object immediately after the timer is started to be executed. The execution unit 18 causes the control unit 11 that controls the workflow associated as an aggregation object immediately after the timer is started to refer to information on another device, so that even when a subsequent similar workflow has occurred, the information referred to before can be shared. As a result, since the control unit 11 can immediately acquire necessary information for each workflow, it is possible to execute the process after the next earlier.

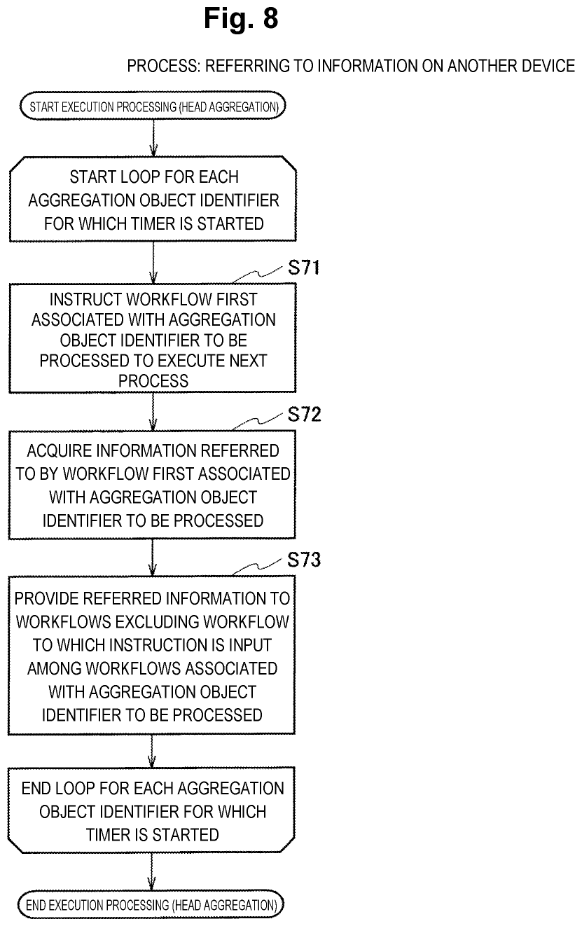

Execution processing performed by the execution unit 18 will be described with reference to FIG. 8. Here, a case will be described where the next waiting process is referring to information on another device and the execution unit 18 outputs an execution instruction to the first associated workflow by head aggregation.

The execution unit 18 performs the processing of steps S71 to S73 for each aggregation object identifier whose timer has expired and for which head aggregation is performed.

In step S71, the execution unit 18 instructs the control unit 11 to execute the next process for the workflow first associated with the aggregation object identifier to be processed.

In step S72, the execution unit 18 acquires information referred to by the control unit 11 for the workflow first associated with the aggregation object identifier to be processed.

In step S73, the execution unit 18 provides the control unit 11 with the information acquired in step S72 for the workflows excluding the workflow for which the referring instruction is input among the workflows associated with the aggregation object identifier to be processed.

When having completed the processing of steps S71 to S73 for each aggregation object identifier whose timer has expired, the aggregation unit 16 ends the processing.

Note that the processing shown in FIG. 8 is an example and not limited to this. In the example shown in FIG. 8, the execution unit 18 may execute the processing of step S73 each time a new aggregation object workflow occurs.

### Processing for Tail Aggregation by Control Device

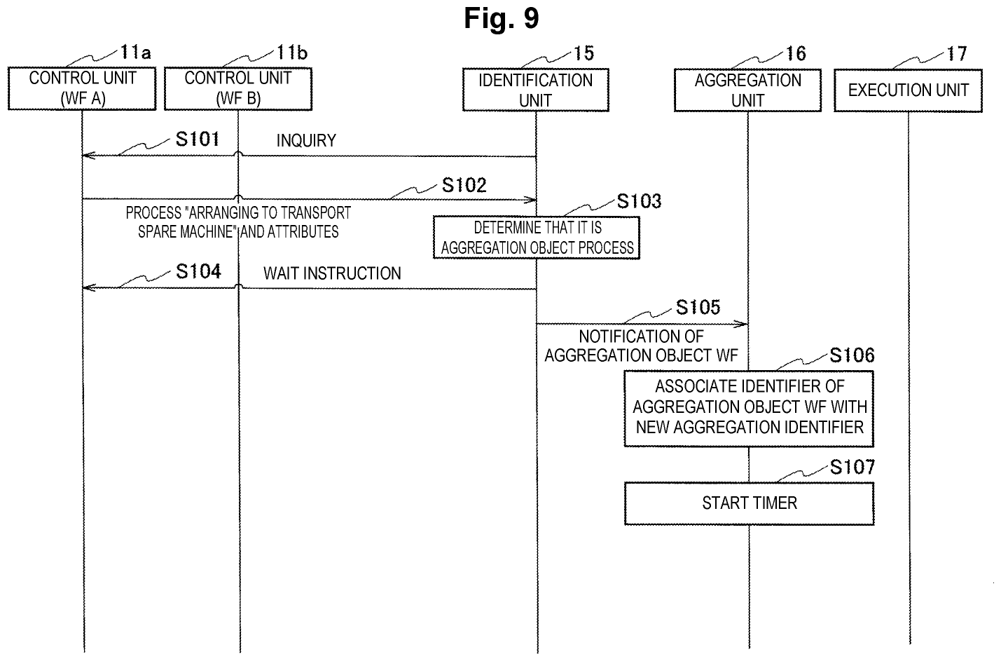

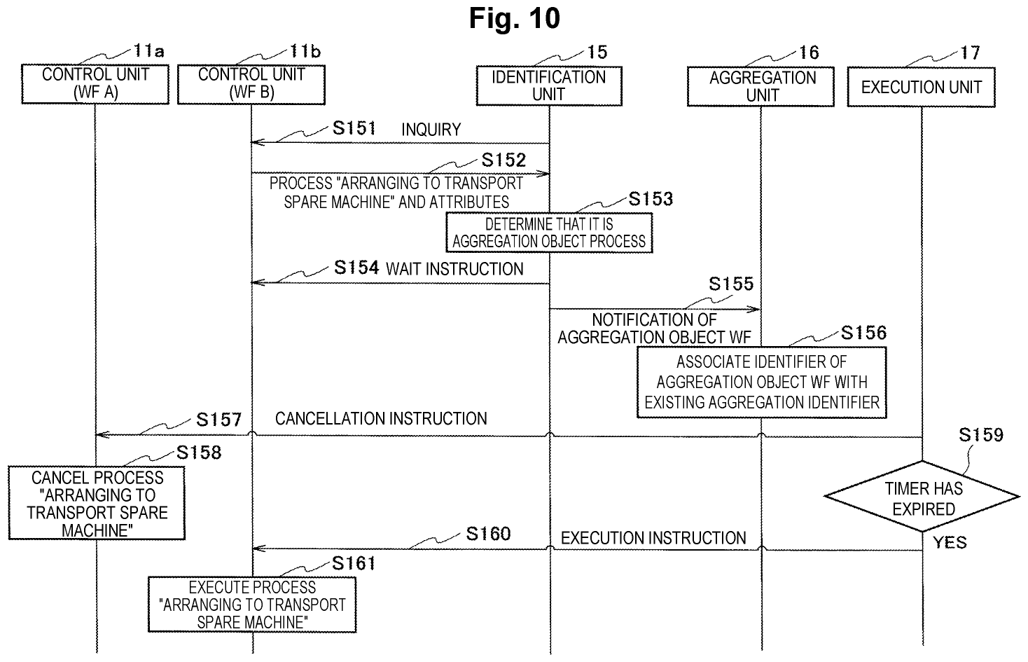

Processing in which tail aggregation is performed will be described with reference to the sequence diagrams in FIGS. 9 and 10. For convenience, the control unit 11 is drawn by dividing it into a control unit 11a that executes a workflow A (WF A) and a control unit 11b that executes a workflow B (WF B). Note that it is assumed that WF A and WF B each wait to execute the same process “arranging to transport a spare machine” and meet the aggregation condition associated with the aggregation object process “arranging to transport a spare machine” in the aggregation rule data 14.

First, the identification unit 15 inquires of the control unit 11a that controls WF A about the waiting process in step S101. In step S102, the identification unit 15 acquires the process “arranging to transport a spare machine” and the attributes of WF A from the control unit 11a.

In step S103, the identification unit 15 determines that the process “arranging to transport a spare machine” is an aggregation object process corresponding to tail aggregation. In step S104, the identification unit 15 notifies the control unit 11a to wait to execute the next process. In step S105, the identification unit 15 notifies the aggregation unit 16 of WF A as an aggregation object WF.

In step S106, the aggregation unit 16 assigns a new aggregation object identifier and associates the identifier of WF A with the new aggregation object identifier as the identifier of an aggregation object WF in the aggregated data 17. Here, the identification unit 15 further sets values identified from the attributes of WF A as the aggregation object process and the aggregation condition. Further, in step S107, the aggregation unit 16 starts a timer associated with the new aggregation object identifier assigned in step S106.

Before the timer started in step S106 expires, the identification unit 15 inquires of the control unit 11b that controls WF B about the waiting process in step S151. In step S152, the execution unit 18 acquires the process “arranging to transport a spare machine” and the attributes of WF B from the control unit 11b.

In step S153, the identification unit 15 determines that the process “arranging to transport a spare machine” is an aggregation object process. In step S154, the identification unit 15 notifies the control unit 11b to wait to execute the next process. In step S155, the identification unit 15 notifies the aggregation unit 16 of WF B as an aggregation object WF.

In step S156, the aggregation unit 16 associates the identifier of WF B with the aggregation object identifier assigned in step S106 as the identifier of an aggregation object WF. In step S157, the execution unit 18 instructs the control unit 11a that controls WF A to cancel the execution of the next process. In step S158, the control unit 11a cancels the execution of the next process.

In step S159, when the timer started in step S107 has expired, the execution unit 18 instructs the control unit 11b to execute the next process in step S160. In step S161, the control unit 11b that controls WF B executes the next process, “arranging to transport a spare machine”. At this time, the control unit 11b may also merge the arrangement contents of “arranging to transport a spare machine” in WF A to change the arrangement contents. The execution unit 18 may acquire the execution result of “arranging to transport a spare machine” from the control unit 11b, and provide the execution result of “arranging to transport a spare machine” to the control unit 11b that controls WF A that has canceled the execution of the next process.

Note that the processing shown in FIGS. 9 and 10 is an example and not limited to this.

### Processing for Head Aggregation by Control Device

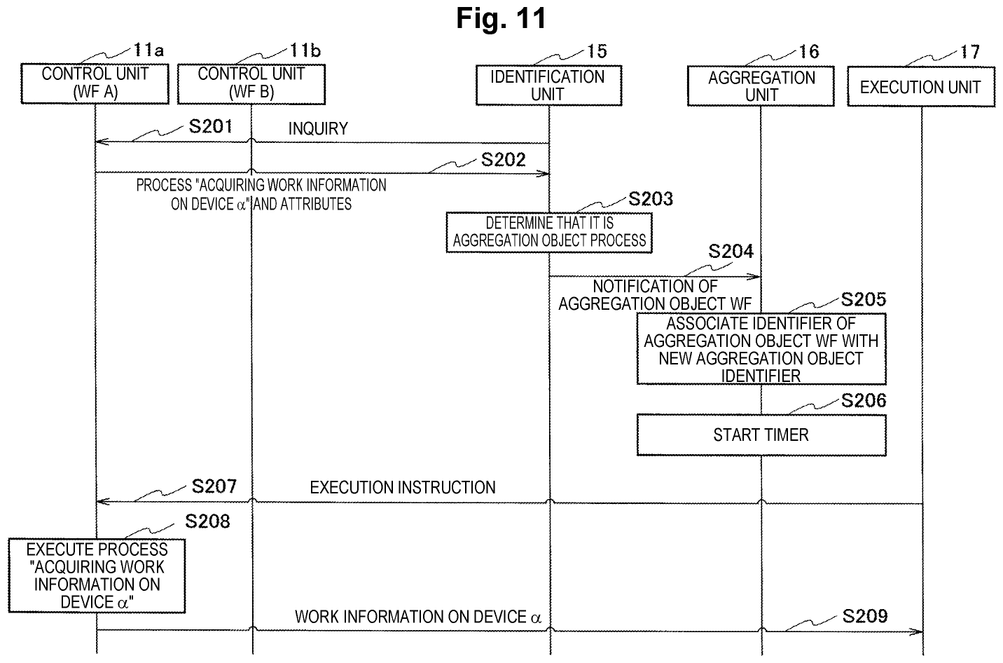

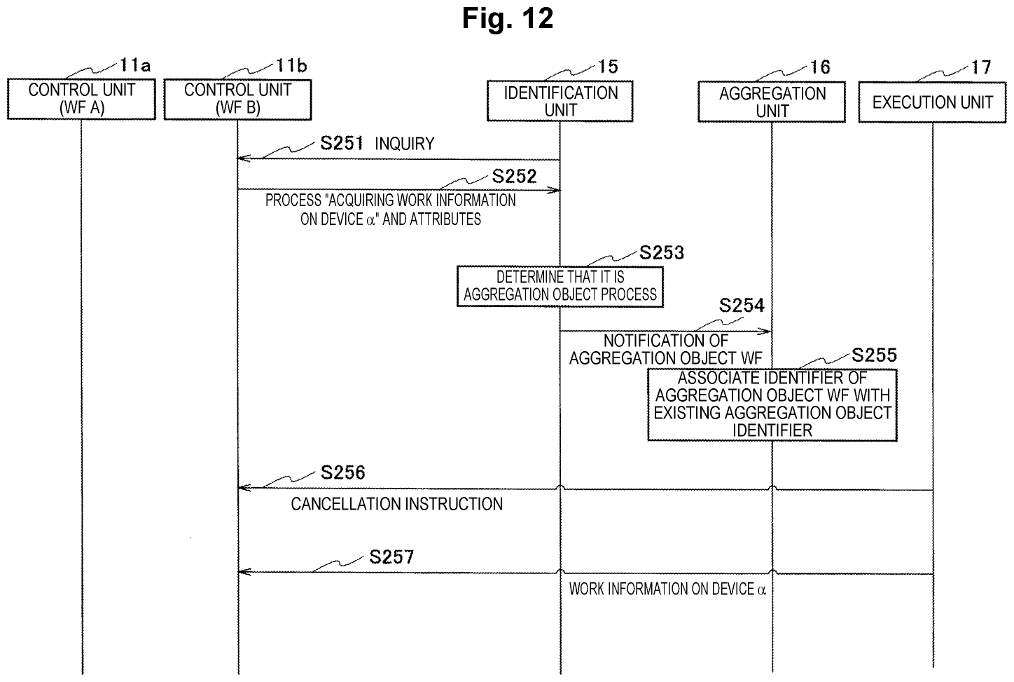

Processing in which head aggregation is performed will be described with reference to the sequence diagrams in FIGS. 11 and 12. For convenience, the control unit 11 is drawn by dividing it into a control unit 11a that executes a workflow A (WF A) and a control unit 11b that executes a workflow B (WF B). Note that it is assumed that WF A and WF B each wait to execute the same process “acquiring work information on the device α” and meet the aggregation condition associated with the aggregation object process “acquiring work information on the device α” in the aggregation rule data 14.

First, the identification unit 15 inquires of the control unit 11a that controls WF A about the waiting process in step S201. In step S202, the identification unit 15 acquires the process “acquiring work information on the device α” and the attributes of WF A from the control unit 11a.

In step S203, the identification unit 15 determines that the process “acquiring work information on the device α” is an aggregation object process corresponding to head aggregation. In step S204, the identification unit 15 notifies the aggregation unit 16 of WF A as an aggregation object WF.

In step S205, the aggregation unit 16 assigns a new aggregation object identifier and associates the identifier of WF A with the new aggregation object identifier as the identifier of an aggregation object WF in the aggregated data 17. Here, the identification unit 15 sets values identified from the attributes of WF A as the aggregation object process and the aggregation condition. Further, in step S206, the aggregation unit 16 starts a timer associated with the new aggregation object identifier assigned in step S205.

In step S207, the execution unit 18 instructs the control unit 11a that controls WF A to execute the next process. In step S208, the control unit 11a executes the next process, “acquiring work information on the device α”. In step S209, the execution unit 18 acquires work information on the device α from the control unit 11a as a result of the process “acquiring work information on the device α”.

Before the timer started in step S206 expires, the identification unit 15 inquires of the control unit 11b that controls WF B about the waiting process in step S251. In step S252, the execution unit 18 acquires the process “acquiring work information on the device α” and the attributes of WF B from the control unit 11b.

In step S253, the identification unit 15 determines that the process “acquiring work information on the device α” is an aggregation object process. In step S254, the identification unit 15 notifies the aggregation unit 16 of WF B as an aggregation object WF.

In step S255, the aggregation unit 16 associates the identifier of WF B with the aggregation object identifier assigned in step S205 as the identifier of an aggregation object WF. In step S256, the execution unit 18 instructs the control unit 11b that controls WF B to cancel the execution of the next process. In step S257, the execution unit 18 provides the control unit 11b with the work information on the device a acquired in step S209 as the execution result of the next process.

Note that the processing shown in FIGS. 11 and 12 is an example and not limited to this.

In the embodiment of the present invention, a workflow waits to execute the next process, and the identification unit 15 acquires information on the next process that the workflow is waiting for. When the next waiting process is aggregation object data defined in the aggregation rule data 14, the identification unit 15 identifies the workflow as an aggregation object. Workflows identified as aggregation objects are aggregated and executed.

As a result, the control device 1 according to the embodiment of the present invention can reduce costs by aggregating a plurality of similar failure responses that have occurred in the same time period. The control device 1 like this is suitable for controlling a network provided by a large-scale communication carrier.

For the control device 1 of this embodiment described above, a general-purpose computer system is used that includes, for example, a CPU (central processing unit, processor) 901, a memory 902, a storage 903 (HDD: hard disk drive, SSD: solid state drive), a communication device 904, an input device 905, and an output device 906. In this computer system, each function of the control device 1 is realized by the CPU 901 executing a control program loaded on the memory 902.

Note that the control device 1 may be implemented by one computer or may be implemented by a plurality of computers. Further, the control device 1 may be a virtual machine implemented on a computer.

The control program for realizing the control device 1 can be stored in a computer-readable recording medium such as an HDD, an SSD, a USB (universal serial bus) memory, a CD (compact disc), or a DVD (digital versatile disc), or can be delivered over a network.

Note that the present invention is not limited to the above embodiment and many modifications can be made within the scope of the gist thereof.

### REFERENCE SIGNS LIST

1 Control device
2 Control object device
11 Control unit
12 External information acquisition unit
13 Workflow data
14 Aggregation rule data
15 Identification unit
16 Aggregation unit
17 Aggregated data
18 Execution unit
901 CPU
902 Memory
903 Storage
904 Communication device
905 Input device
906 Output device

1. A control device comprising:
a storage configured to store:
aggregation rule data that associates an aggregation object process of processes in a workflow in which a computer handles failure of a device with an aggregation condition identified from an attribute of the workflow, and
aggregated data that associates an identifier of an aggregation object workflow with an aggregation identifier and that associates an aggregation object process and an aggregation condition identified from an attribute of the aggregation object workflow with the aggregation identifier;
an identification unit, implemented using one or more computing devices, configured to identify a workflow waiting to execute an aggregation object process in the aggregation rule data;
an aggregation unit, implemented using one or more computing devices, configured to associate an identifier of the identified workflow with an aggregation identifier associated with a process that the identified workflow is waiting to execute and an aggregation condition identified from an attribute of the identified workflow in the aggregated data; and
an execution unit, implemented using one or more computing devices, configured to output an instruction to aggregate and execute a process that the workflow associated with the aggregation identifier in the aggregated data is waiting to execute.

2. The control device according to claim 1, wherein the execution unit is configured to output the instruction by a time a timer for specifying timing of executing the process expires is waiting to execute.

3. The control device according to claim 2, wherein:
the process waiting to be executed is an operation on another device, and
after the timer has expired, the execution unit is configured to output an instruction to aggregate and execute an operation on another device executed by each workflow associated with the aggregation identifier.

4. The control device according to claim 2, wherein:
the process waiting to be executed refers information, and
after the timer is started, the execution unit is configured to output (i) an instruction to acquire the information and (ii) an instruction to provide the information to each workflow associated with the aggregation identifier.

5. The control device according to claim 1, wherein:
for one of workflows associated with the aggregation identifier, the execution unit is configured to:
input an instruction to aggregate and execute a process that the workflow is waiting to execute, and
output an instruction to cancel execution for workflows other than the workflow for which the instruction is input among workflows associated with the aggregation identifier.

6. The control device according to claim 1, wherein, for a workflow waiting to execute a next process, the identification unit is configured to, based on the next process not being an aggregation object process, output an instruction to execute the next process.

7. A control method comprising:
storing in a storage, by a computer, (i) aggregation rule data that associates an aggregation object process of processes in a workflow for handling failure of a device with an aggregation condition identified from an attribute of the workflow and (ii) aggregated data that associates an identifier of an aggregation object workflow with an aggregation identifier and that associates an aggregation object process and an aggregation condition identified from an attribute of the aggregation object workflow with the aggregation identifier;
identifying, by the computer, a workflow waiting to execute an aggregation object process in the aggregation rule data;
associating, by the computer, an identifier of the identified workflow with an aggregation identifier associated with a process that the identified workflow is waiting to execute and an aggregation condition identified from an attribute of the identified workflow in the aggregated data; and
outputting, by the computer, an instruction to aggregate and execute a process that the workflow associated with the aggregation identifier in the aggregated data is waiting to execute.

8. A non-transitory recording medium storing a control program, wherein execution of the control program causes a computer to perform operations comprising:
storing in a storage, by a computer, (i) aggregation rule data that associates an aggregation object process of processes in a workflow for handling failure of a device with an aggregation condition identified from an attribute of the workflow and (ii) aggregated data that associates an identifier of an aggregation object workflow with an aggregation identifier and that associates an aggregation object process and an aggregation condition identified from an attribute of the aggregation object workflow with the aggregation identifier;
identifying, by the computer, a workflow waiting to execute an aggregation object process in the aggregation rule data;
associating, by the computer, an identifier of the identified workflow with an aggregation identifier associated with a process that the identified workflow is waiting to execute and an aggregation condition identified from an attribute of the identified workflow in the aggregated data; and
outputting, by the computer, an instruction to aggregate and execute a process that the workflow associated with the aggregation identifier in the aggregated data is waiting to execute.

9. The recording medium according to claim 8, wherein outputting the instruction comprises outputting the instruction by a time a timer for specifying timing of executing the process expires is waiting to execute.

10. The recording medium according to claim 9,
wherein the process waiting to be executed is an operation on another device, and
wherein the operations further comprise, after the timer has expired, outputting an instruction to aggregate and execute an operation on another device executed by each workflow associated with the aggregation identifier.

11. The recording medium according to claim 9,
wherein the process waiting to be executed refers to information, and
wherein the operations further comprise, after the timer is started, outputting (i) an instruction to acquire the information and (ii) an instruction to provide the information to each workflow associated with the aggregation identifier.

12. The recording medium according to claim 8,
wherein, for one of workflows associated with the aggregation identifier, the operations further comprise:
inputting an instruction to aggregate and execute a process that the workflow is waiting to execute, and
outputting an instruction to cancel execution for workflows other than the workflow for which the instruction is input among workflows associated with the aggregation identifier.

13. The recording medium according to claim 8,
wherein, for a workflow waiting to execute a next process, the operations further comprise, based on the next process not being an aggregation object process, outputting an instruction to execute the next process.
